(19) United States
(12) Patent Application Publication
(10) Pub. No.: US 2014/0002645 A1
(43) Pub. Date: Jan. 2, 2014

(54) SERVER AND VIDEO SURVEILLANCE METHOD OF TARGET PLACE

(71) Applicant: HON HAI PRECISION INDUSTRY CO., LTD., New Taipei (TW)

(72) Inventor: CHUI-WEN CHIU, New Taipei (TW)

(73) Assignee: HON HAI PRECISION INDUSTRY CO., LTD., New Taipei (TW)

(21) Appl. No.: 13/899,614

(22) Filed: May 22, 2013

(30) Foreign Application Priority Data
Jun. 29, 2012 (TW) 101123434

(51) Int. Cl. H04N 7/18

(52) U.S. Cl. CPC H04N 7/18
USPC 348/143

(57) ABSTRACT

In a video surveillance method of a target place using a server, the server connects to at least one image source device and one or more terminal devices through a remote frame buffer (RFB) network. An image request is received from one of the terminal devices, and a frame of real-time image acquired from the image source device according to the image request. The method encodes the real-time image to an RFB formatted data stream, generates an image updating command when the terminal device updates the real-time image, updates the RFB formatted data stream according to the image updating command, and displays the real-time image on the terminal device according to the updated RFB formatted data stream. The method controls the image source device to perform a PTZ operation event when the PTZ operation event is received from the terminal device.

### BACKGROUND

1. Technical Field

Embodiments of the present disclosure relate to image surveillance systems and methods, and particularly to a server and a video surveillance method of a target place using the server.

2. Description of Related Art

In traditional image surveillance systems, a monitor device obtains videos or images captured by one or more image source devices as the videos or images are captured. The image source devices, such as video recorders or IP cameras, show the videos or image on a terminal device (e.g., a mobile device or a computer). The videos or image may be transmitted over a network between the terminal device and each of the image source devices. Transmission of large videos or images may employ much bandwidth of the network, and may result in an image transmission delay of the network. If a user performs an operation (such as a pan, tilt, zoom, hereinafter “PTZ”) on the videos or images through the terminal device, the response time of the operation may increase because of image transmission delay in the network. Therefore, there is room for improvement within the traditional image surveillance systems.

### BRIEF DESCRIPTION OF THE DRAWINGS

FIG. 1 is a block diagram of one embodiment of a server including a video surveillance system.

FIG. 2 is a flowchart of one embodiment of a video surveillance method of a target place using the server in FIG. 1

FIG. 3 is a detailed flowchart of step S30 in FIG. 2.

FIG. 4 shows one exemplary embodiment of a PTZ operation on an real-time image displayed on a terminal device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

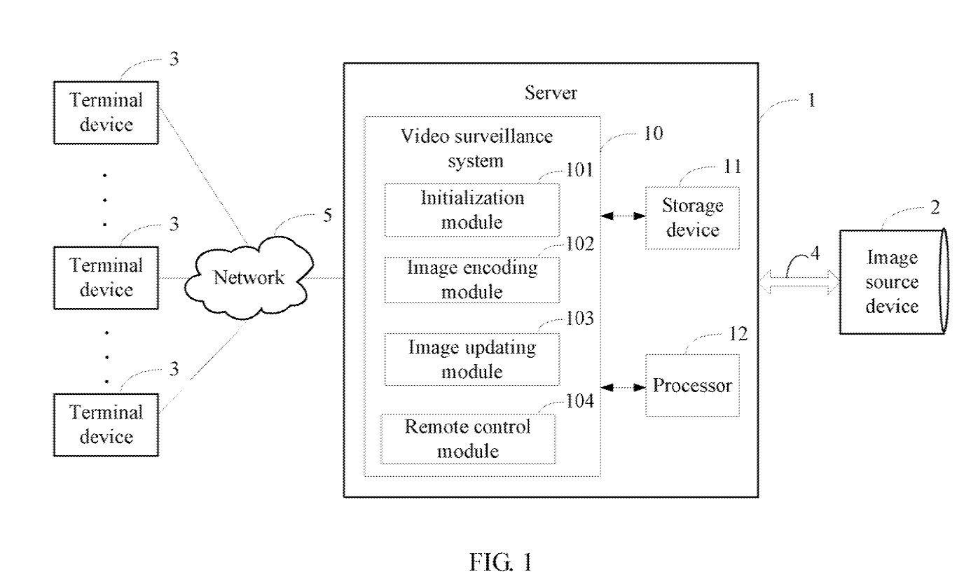

FIG. 1 is a block diagram of one embodiment of a server 1 including a video surveillance system 10. In the embodiment, the server 1 connects to at least one image source device 2 through a real-time streaming protocol (RTSP) cable 4, and connects to a plurality of terminal devices 3 through a remote frame buffer (RFB) network 5, which transfers video data according to a remote frame buffer (RFB) protocol. The server 1 includes, but is not limited to, a storage device 11 and at least one processor 12. In one embodiment, the video surveillance system 10 may include computerized instructions in the form of one or more programs that are stored in the storage device 11 and executed by the at least one processor 12. FIG. 1 illustrates only one example of the server 1, other examples may include more or fewer components than illustrated, or have a different configuration of the various components in other embodiments.

The server 1 is a computing device having a virtual network control (VNC) function, which processes one or more real-time images captured by the image source device 2, and transmits the real-time images to the terminal devices 3 according to the RFB protocol. The image source device 2 may be a network video recorder (NVR) or an internet protocol (IP) camera that monitors a target place (such as a supermarket, or a workshop) and captures images of the target place in real-time. Each of the terminal devices 3 may be a monitor device, a personal computer, a mobile device, or a personal digital assistant (PDA) device. Each of the terminal devices 3 displays the real-time images to be viewed by a user, so that the user can visually monitor the target place.

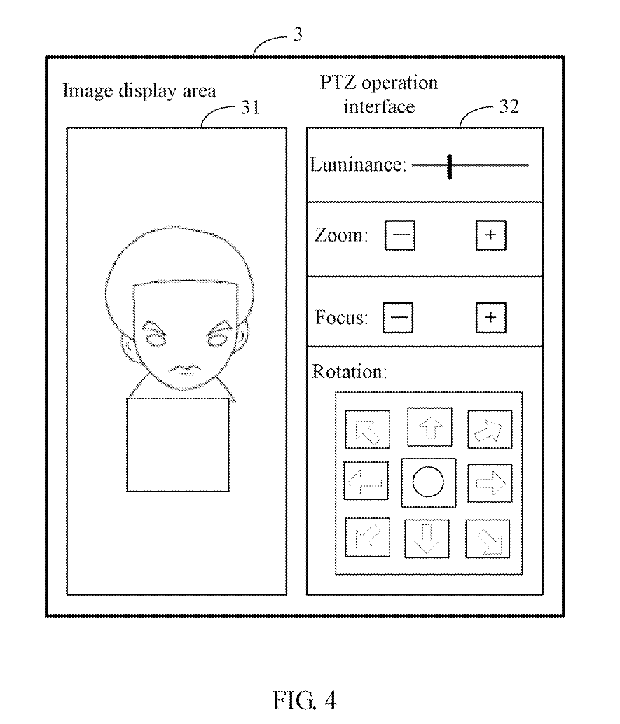

In the embodiment, a user can perform a PTZ (pan, tilt, and zoom) operation on the images through any of the terminal devices 3. Each of the terminal devices 3 includes an image display area 31 and a PTZ operation interface 32. The image display area 31 displays the real-time images captured from the image source device 2, and the PTZ operation interface 32 provides a plurality of PTZ operations on the image source device 2 to capture the real-time images from the target place. Referring to FIG. 4, the PTZ operation interface 32 include an icon for adjusting luminance of the real-time images, an icon for zooming in or out a lens of the image source device 2, an icon for adjusting a focus of the lens of the image source device 2, and a plurality of icons for performing a rotating operation on the real-time images.

In one embodiment, the storage device 11 may be an internal storage system, such as a random access memory (RAM) for temporary storage of information, and/or a read only memory (ROM) for permanent storage of information. The storage device 11 may also be an external storage system, such as an external hard disk, a storage card, or a data storage medium. The processor 12 is a central processing unit (CPU) or microprocessor that performs various functions of the server 1.

In one embodiment, the video surveillance system 10 includes an initialization module 101, an image encoding module 102, an image updating module 103, and a remote control module 104. The modules 101-104 may comprise computerized instructions in the form of one or more programs that are stored in the storage device 11 and executed by the at least one processor 12. A description of each module is given in the following paragraphs.

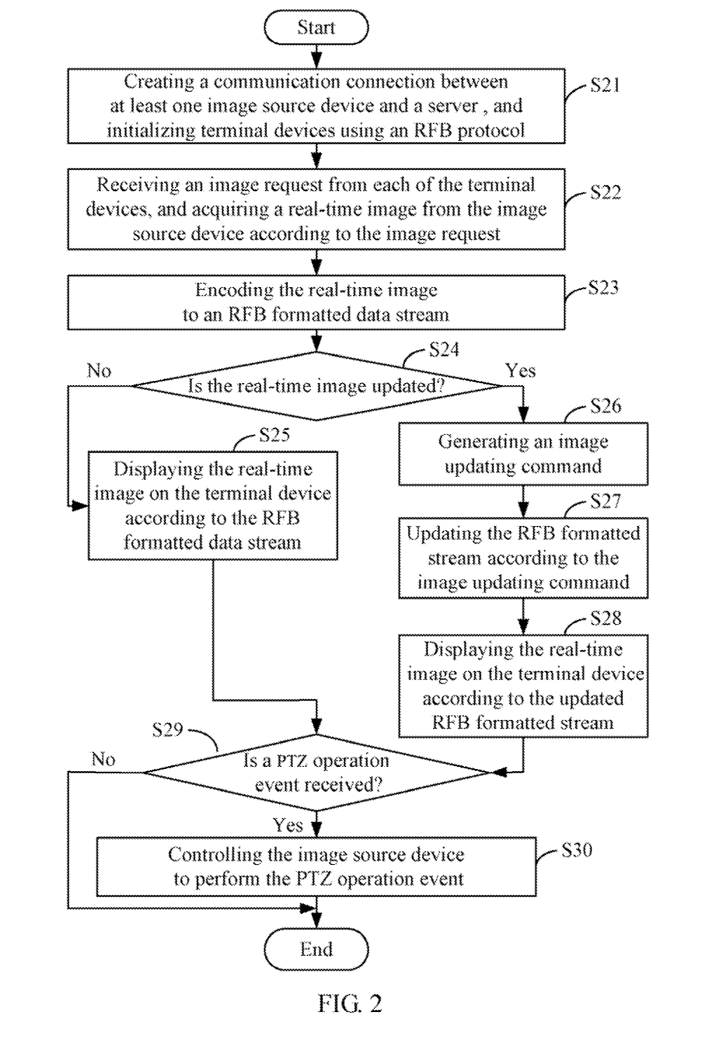

FIG. 2 is a flowchart of one embodiment of a video surveillance method of a target place using the server 1 in FIG. 1. The method is performed by execution of a computer-readable program code or instructions by the at least one processor 12 of the server 1. Depending on the embodiment, additional steps may be added, others removed, and the ordering of the steps may be changed.

In step S21, the initialization module 101 creates a communication connection between at least one image source device 2 and the server 1, and initializes each terminal device 3 using a remote frame buffer (RFB) protocol. In the embodiment, the server 1 connects to the at least one image source device 2 through the RTSP cable 4, and connects to each of the terminal devices 3 through the RFB network 5, which transfers video data according to the RFB protocol. For example, the initialization module 101 uses a Set_Pixel_format function to initialize a resolution of the image displayed on each of terminal devices 3.

In step S22, the image encoding module 102 receives an image request from one of the terminal devices 3, and acquires a single frame of a real-time image from the image source device 2 according to the image request. In the embodiment, the terminal device 3 sends the image request to the server 1 through the RFB network 5, and the server 1 acquires the real-time image from the image source device 2 through the RTSP cable 4.

In step S23, the image encoding module 102 encodes the real-time image to a RFB formatted data stream. The RFB formatted data stream is a type of image data with a RFB data format that complies with the RFB protocol. In the embodiment, the image encoding module 102 uses a Set_Encoding function to encode the real-time image, and generates the RFB formatted data stream that can be transferred over the RFB network 5.

In step S24, the image updating module 103 determines whether the real-time image needs to be updated in the terminal device 3. In the embodiment, the image updating module 103 checks any image difference between a currently displayed image and the real-time image in the RFB formatted data stream, and determines whether the real-time image needs to be updated according to the image difference. If the real-time image is not updated in the terminal device, step S25 is implemented. Otherwise, the real-time image is updated in the terminal device, step S26 is implemented.

In step S25, the image updating module 103 transmits the RFB formatted data stream to the terminal device 3 through the RFB network 5, and displays the real-time image on the terminal device 3 according to the RFB formatted data stream. The terminal device 3 decodes the RFB formatted data stream to display the real-time image when the RFB formatted data stream is received from the server 1.

In step S26, the image updating module 103 generates an image updating command for updating the real-time image from the image source device 2. For example, the image updating module 103 generates a Frame_Buffer_Updated_Request command to update the resolution of the image being captured by the image source device 2. In the embodiment, the resolution of the image being captured is denoted as 1024*768 pixels.

In step S27, the image updating module 103 updates the RFB formatted data stream according to the image updating command In the embodiment, the RFB formatted data stream is updated according to the Frame_Buffer_Updated_Request command.

In step S28, the image updating module 103 transmits the updated RFB formatted data stream to the terminal device 3 through the RFB network 5, and displays the real-time image on the terminal device 3 according to the updated RFB formatted data stream.

In step S29, the remote control module 104 determines whether a PTZ operation event is required by the terminal device 3. In one embodiment, the PTZ operation event is input by a user from the PTZ operation interface 32 of the terminal device 3. Referring to FIG. 4, the PTZ operation event includes a luminance adjustment event, an image zooming event, a focus adjustment event, and an image rotation event. If the PTZ operation event is required by the terminal device 3, step S30 is implemented. If no PTZ operation event is required by the terminal device 3, the process ends.

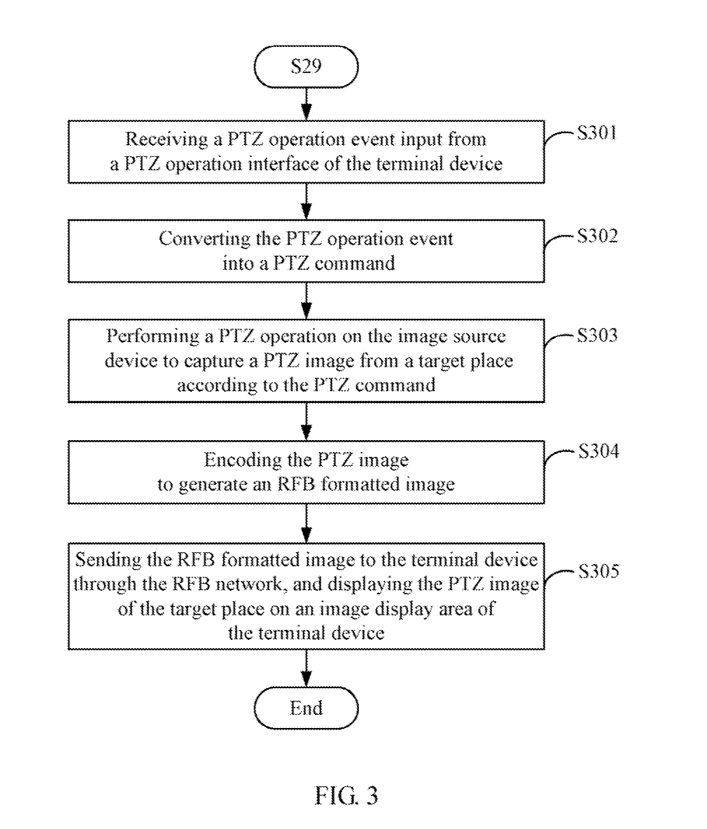

In step S30, the remote control module 104 controls the image source device 2 to perform the PTZ operation event required by the terminal device 3. In the embodiment, the image source device 2 performs the PTZ event when the user inputs the PTZ operation event from the PTZ operation interface 32 of the terminal device 3. The description of step S30 is illustrated in FIG. 3.

FIG. 3 is a detailed flowchart of step S30 in FIG. 2. In step S301, the remote control module 104 receives the PTZ operation event input from the PTZ operation interface 32 of the terminal device 3. For example, the user may input an image zoom-in even through the PTZ operation interface 32, for zooming-in to an image currently being captured by the image source device 2.

In step S302, the remote control module 104 converts the PTZ operation event into a PTZ command, such as an image zoom-in command, for example. In step S303, the remote control module 104 performs a PTZ operation on the image source device 2 to capture a PTZ image from the target place according to the PTZ command. For example, if the PTZ operation event is the image zoom-in event, the PTZ image may be zoomed in to capture an enlarged image of the image being currently captured, according to the image zoom-in command.

In step S304, the remote control module 104 encodes the PTZ image to generate an RFB formatted image. In step S305, the remote control module 104 sends the RFB formatted image to the terminal device 3 through the RFB network 5, and displays the PTZ image of the target place on the image display area 31 of the terminal device 3 according to the PTZ command.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A server being connected to at least one image source device and a plurality of terminal devices through a remote frame buffer (RFB) network, the server comprising:
at least one processor; and
a storage device storing one or more computer-readable programs, which when executed by the at least one processor, causes the at least one processor to:
create a communication connection between the at least one image source device and the server, and initialize each of terminal devices according to an RFB protocol;
receive an image request from one of the terminal devices, and acquire a real-time image from the image source device according to the image request;
encode the real-time image to a RFB formatted data stream;
display the real-time image on the terminal device according to the RFB formatted data stream if the real-time image is not updated in the terminal device;
generate an image updating command and update the RFB formatted data stream according to the image updating command, and display the real-time image on the terminal device according to the updated RFB formatted data stream, if the real-time image is updated in the terminal device; and
control the image source device to perform a PTZ (pan, tilt, and zoom) operation event when the PTZ operation event is received from the terminal device.

2. The server according to claim 1, wherein each of the terminal devices comprises an image display area that displays the real-time image captured from the image source device, and a PTZ operation interface that provides a plurality of PTZ operations on the image source device.

3. The server according to claim 1, wherein the PTZ operation event is performed by steps of:
receiving the PTZ operation event input from a PTZ operation interface of the terminal device;
converting the PTZ operation event into a PTZ command;
performing a PTZ operation on the image source device to capture a PTZ image from the target place according to the PTZ command;
encoding the PTZ image to generate an RFB formatted image; and
sending the RFB formatted image to the terminal device through the RFB network, and displaying the PTZ image of the target place on an image display area of the terminal device.

4. The server according to claim 1, wherein the PTZ operation event comprises a luminance adjustment event, an image zooming event, a focus adjustment event, and an image rotation event.

5. The server according to claim 1, wherein the image source device is a network video recorder (NVR) or an internet protocol (IP) camera that monitors the target place and captures one or more real-time images from the target place.

6. The server according to claim 1, wherein the one or more computer-readable programs further cause the at least one processor to check an image difference between an image currently displayed on the terminal device and the real-time image in the RFB formatted data stream, and determine whether the real-time image needs to be updated according to the image difference.

7. A video surveillance method of a target place using a server, the server being connected to at least one image source device and a plurality of terminal devices through a remote frame buffer (RFB) network, the method comprising:
creating a communication connection between the at least one image source device and the server, and initializing each of terminal devices according to an RFB protocol;
receiving an image request from one of the terminal devices, and acquiring a real-time image from the image source device according to the image request;
encoding the real-time image to an RFB formatted data stream;
displaying the real-time image on the terminal device according to the RFB formatted data stream if the real-time image is not updated in the terminal device;
generating an image updating command and updating the RFB formatted data stream according to the image updating command, and displaying the real-time image on the terminal device according to the updated RFB formatted data stream, if the real-time image is updated in the terminal device; and
controlling the image source device to perform a PTZ (pan, tilt, and zoom) operation event when the PTZ operation event is received from the terminal device.

8. The method according to claim 7, wherein each of the terminal devices comprises an image display area that displays the real-time image captured from the image source device, and a PTZ operation interface that provides a plurality of PTZ operations on the image source device.

9. The method according to claim 7, wherein the PTZ operation event is performed by steps of:
receiving the PTZ operation event input from a PTZ operation interface of the terminal device;
converting the PTZ operation event into a PTZ command;
performing a PTZ operation on the image source device to capture a PTZ image from the target place according to the PTZ command;
encoding the PTZ image to generate an RFB formatted image; and
sending the RFB formatted image to the terminal device through the RFB network, and displaying the PTZ image of the target place on an image display area of the terminal device.

10. The method according to claim 7, wherein the PTZ operation event comprises a luminance adjustment event, an image zooming event, a focus adjustment event, and an image rotation event.

11. The method according to claim 7, wherein the image source device is a network video recorder (NVR) or an internet protocol (IP) camera that monitors the target place and captures one or more real-time images from the target place.

12. The method according to claim 7, further comprising:
checking an image difference between an image currently displayed on the terminal device and the real-time image in the RFB formatted data stream; and
determining whether the real-time image needs to be updated according to the image difference.

13. A non-transitory storage medium having stored thereon instructions that, when executed by at least one processor of a server, cause the server to perform a video surveillance method of a target place, the server being connected to at least one image source device and a plurality of terminal devices through a remote frame buffer (RFB) network, the method comprising:
creating a communication connection between the at least one image source device and the server, and initializing each of terminal devices according to an RFB protocol;
receiving an image request from one of the terminal devices, and acquiring a real-time image from the image source device according to the image request;
encoding the real-time image to an RFB formatted data stream;
displaying the real-time image on the terminal device according to the RFB formatted data stream if the real-time image is not updated in the terminal device;
generating an image updating command and updating the RFB formatted data stream according to the image updating command, and displaying the real-time image on the terminal device according to the updated RFB formatted data stream, if the real-time image is updated in the terminal device; and
controlling the image source device to perform a PTZ (pan, tilt, and zoom) operation event when the PTZ operation event is received from the terminal device.

14. The storage medium according to claim 13, wherein each of the terminal devices comprises an image display area that displays the real-time image captured from the image source device, and a PTZ operation interface that provides a plurality of PTZ operations on the image source device.

15. The storage medium according to claim 13, wherein the PTZ operation event is performed by steps of:
receiving the PTZ operation event input from a PTZ operation interface of the terminal device;
converting the PTZ operation event into a PTZ command;
performing a PTZ operation on the image source device to capture a PTZ image from the target place according to the PTZ command;
encoding the PTZ image to generate an RFB formatted image; and
sending the RFB formatted image to the terminal device through the RFB network, and displaying the PTZ image of the target place on an image display area of the terminal device.

16. The storage medium according to claim 13, wherein the PTZ operation event comprises a luminance adjustment event, an image zooming event, a focus adjustment event, and an image rotation event.

17. The storage medium according to claim 13, wherein the image source device is a network video recorder (NVR) or an internet protocol (IP) camera that monitors the target place and captures one or more real-time images from the target place.

18. The storage medium according to claim 13, wherein the method further comprises:
checking an image difference between an image currently displayed on the terminal device and the real-time image in the RFB formatted data stream; and
determining whether the real-time image needs to be updated according to the image difference.
